(19) United States
(12) Patent Application Publication
(10) Pub. No.: US 2015/0012531 A1
(43) Pub. Date: Jan. 8, 2015

(54) Online Method and System for Identifying Potential Friends and Building Real Friendships Therebetween

(71) Applicant: Jesse Armstrong, Lee's Summit, MO (US)

(72) Inventor: Jesse Armstrong, Lee's Summit, MO (US)

(21) Appl. No.: 14/326,455

(22) Filed: Jul. 8, 2014

Related U.S. Application Data
(60) Provisional application No. 61/843,562, filed on Jul. 8, 2013.

(51) Int. Cl. G06F 17/30; G06F 3/0482

(52) U.S. Cl. CPC G06F 17/30867; G06F 3/0482
USPC 707/733; 707/758

(57) ABSTRACT

An online system collects extensive profile information from users, performs a matching process that identifies best matches between users as potential friends, and performs a bonding process that challenges the matched users to tasks that serve to reinforce and deepen the level of friendship between the matched users. The bonding process includes a plurality of increasingly more personal levels of friendship that are achieved by accomplishing a plurality of increasingly personal challenges that must be completed before moving on to the next level. The ultimate level of bonding is best friends.

### CROSS-REFERENCE TO RELATED APPLICATIONS

This application claims the benefit of priority from U.S. Provisional Application Ser. No. 61/843,562, filed Jul. 8, 2014 and entitled “Process to Connect People Together and Build a Relationship,” which is incorporated herein in its entirety by this reference.

### FIELD OF THE INVENTION

This application relates generally to social media, and more specifically to online community-based friendships.

### BACKGROUND OF THE INVENTION

Friendship is the cornerstone of societal interpersonal relationships. Yet, notwithstanding the ever-increasing levels of connectivity among people through their personal digital assistant devices (PDAs), it can be in many ways more difficult to establish truly deep and heart-felt friendships. In today's world of high technology, social media, and high-speed connectivity thereto, people are increasingly remaining at home. This is true whether they are seeking social interaction, entertainment or even in performing work. Thus, people are increasingly seeking “friends” through social media sites such as Facebook, even though most users of Facebook have never even met the vast majority of those “friends” in person.

While social media sites such as Facebook make some attempt to recommend possible new friends to users, these recommendations are typically based upon friends of friends. Web sites that exist for the purposes of matching people as platonic friends or even for potential romantic relationships employ matching criteria that are typically quite limited. They are often made based solely on personality profiles and match criteria chosen by the user, such as age range, ethnic background, religious affiliations or lack thereof, political affiliations of lack thereof, and physical attributes such as height, weight, build, etc. As such, the matches are not very reliable.

Finally, the interaction process provided by the web site usually ends at the point of an introduction between potential matches, or the opportunity exchange messages. Such web sites are not typically involved in the process of helping to establish a true friendship or romantic connection between the matched users beyond the initial attempt to provide potential matches and to facilitate an initial introduction.

### SUMMARY OF THE INVENTION

The present invention is an online system that identifies potential friends through a global matching process, and then facilitates a bonding process by which identified potential friends reinforce their friendship through a series of friendship levels by meeting challenges that serve to deepen and reinforce the friendship. The invention could also be embodied as a software system product that is used to provide a website environment hosted by one or more computer processing devices and databases. Such an embodiment can include one or more software components that may be distributed among, and executed by, a plurality of computer processing devices, including those that provide the hosting and database services, as well as personal information processing devices such as personal computers, smartphones, tablets and the like employed by users to access the website.

In an embodiment, an online system of the invention identifies potential friends among users and building real friendships therebetween, the system including a database for receiving and storing user global profile information for each user, at least one computer processing device coupled to the database, the computer processing device accessible to the users over a network, a matching engine for identifying best matches between users based on a comparison of the profile information of each of the users, and a bonding engine for leading matched users through a bonding process to reinforce and deepen their friendship.

In a further embodiment, the bonding process includes a plurality of levels, each of the levels being increasingly more personal.

In another embodiment, each of the plurality of levels includes a plurality of challenges that must be met by the matched users before they can move on to the next of the plurality of challenges.

In yet another embodiment, each of the plurality of challenges must be performed before the matched users can move from a current level of friendship to a next level of friendship.

In a further embodiment, meeting each of the challenges includes uploading media files to create a photobook by which to chronicle the bonding process.

In yet another embodiment, the matching process includes the matching of user profile information selected by a user from a dropdown menu of a user interface.

In a further embodiment, the matching process includes matching user profile information that is text typed into a text field of a user interface.

In a still further embodiment, the matching process compares individual pieces of user profile information for two users, and assigns a positive value for an exact match of the information, assigns a negative value for a complete lack of a match of the information, and a neutral value for a partial match of the information.

In another embodiment, an overall match value between users is obtained by adding the assigned.

In another embodiment, an overall match value between users is obtained as a percentage of matched pieces of profile information versus total pieces of compared profile information.

In other aspects of the invention, a method for identifying potential friends among users and building real friendships therebetween includes providing a database for receiving and storing user global profile information for each user, providing at least one computer processing device coupled to the database, the computer processing device accessible to the users over a network, identifying best matches between users based on a comparison of the profile information of each of the users, and leading matched users through a bonding process to reinforce and deepen their friendship.

### BRIEF DESCRIPTION OF THE DRAWINGS

The following description can be better understood in light of Figures, in which:

FIG. 1 illustrates a general procedural flow representation of an embodiment of a process for identifying and developing friendships;

FIG. 2 illustrates a general procedural representation of an embodiment of a bonding process of the invention for developing a friendship bond of increasing levels of strength with a user match;

FIG. 3 illustrates a general procedural representation of a process of the invention for determining whether users participating in the bonding process will proceed to the next level of bonding;

FIG. 4 illustrates an embodiment of a Home/Log-in/Sign-up web page of the invention;

FIGS. 5A-B illustrate embodiments of User Profile Input Interface web pages of the invention;

FIG. 6 illustrates an embodiment of a Matching Options web page of the invention;

FIG. 7 illustrates an embodiment of a My Profile web page of the invention displaying information regarding a user's own Profile as a summary of the information input through the web pages of FIGS. 5A and 5B;

FIG. 8 illustrates an example of a matching process of the invention for determining potential friend matches for users based on their user profile information

FIG. 9 illustrates an embodiment of a Friend's Profile web page of the invention that displays a user's profile information to a friend;

FIG. 10 illustrates an embodiment of a Home web page of the invention displayed for a user who is logged in;

FIG. 11 illustrates an embodiment of a Friendship Challenge web page of the invention;

FIG. 12 illustrates an embodiment of a Challenge Presentation web page of the invention;

FIG. 13 illustrates an embodiment of an Achievement web page of the invention pertinent to a particular challenge met with a particular friend;

FIG. 14 illustrates an embodiment of a global Achievements/Photobook web page of the invention;

FIG. 15 illustrates an embodiment of a Friendship Levels web page of the invention;

FIG. 16 illustrates an embodiment of a global Life Reports web page of the invention;

FIG. 17 illustrates an embodiment of a global Friends web page of the invention.

### DETAILED DESCRIPTION

The present invention is an online knowledge verification system, method and software system product that provides community-based knowledge certification. In an embodiment, the system can be provided as a hosted website that is accessible over the Internet by members of the general public who are willing to register with the website. In other embodiments, the invention can also be employed to provide knowledge certification for more limited groups such as employees of a corporation or members of an association, through private networks or virtual private networks (VPNs) that are only accessible to those certain individuals to whom access has been granted.

The website can be hosted by a web hosting service as is well known in the art, and is typically stored in non-transitory memory in association with one or more computer processing devices such as servers. The one or more servers access the non-transitory memory for some or all of the software components necessary for carrying out the method of the invention. The one or more servers may further include one or more processing devices for retrieving from the non-transitory memory the software instructions of those software components, and for executing the retrieved instructions necessary to carry out the method of the invention. The one or more servers can also be supported by one or more databases stored on the non-transitory memory media, to and from which data necessary for operation and maintenance of the hosted website of the invention can be stored and retrieved respectively.

The website of the invention can be accessed through a network such as the Internet, by remote users using any number of possible personal processing devices such as Personal Data Assistants (PDAs), smart phones, desktop and laptop computers, tablets and the like. It will be appreciated by those of skill in the art that these devices also include non-transitory memory media for storing software and one or more processing devices for retrieving and executing the instructions of the software.

The method of the invention can be carried out by the hosting computers and database systems through execution of some or all of the software components of the software system product, in response to commands transmitted from personal processing devices as described above, including the display of web pages and user interface components of the web pages. The commands can be provided by standard browser software stored on and executed by the personal processing devices, or by way of application software components that can be downloaded from the hosted site or from some other application software providers to the personal processing devices of users.

Thus, it will be appreciated by those of skill in the art that the software system product of the invention can be distributed as cooperative software components among, and are therefore executed by, a number of processing devices. Thus the various software product components taken together are configured in the form of a software system product. It will also be appreciated that the various components of the software system are stored in the non-transitory memory media associated with processor devices used to access and execute the software as instructions from the memory media. The execution of those instructions by the one or more processors taken together, thereby carry out the method of the invention.

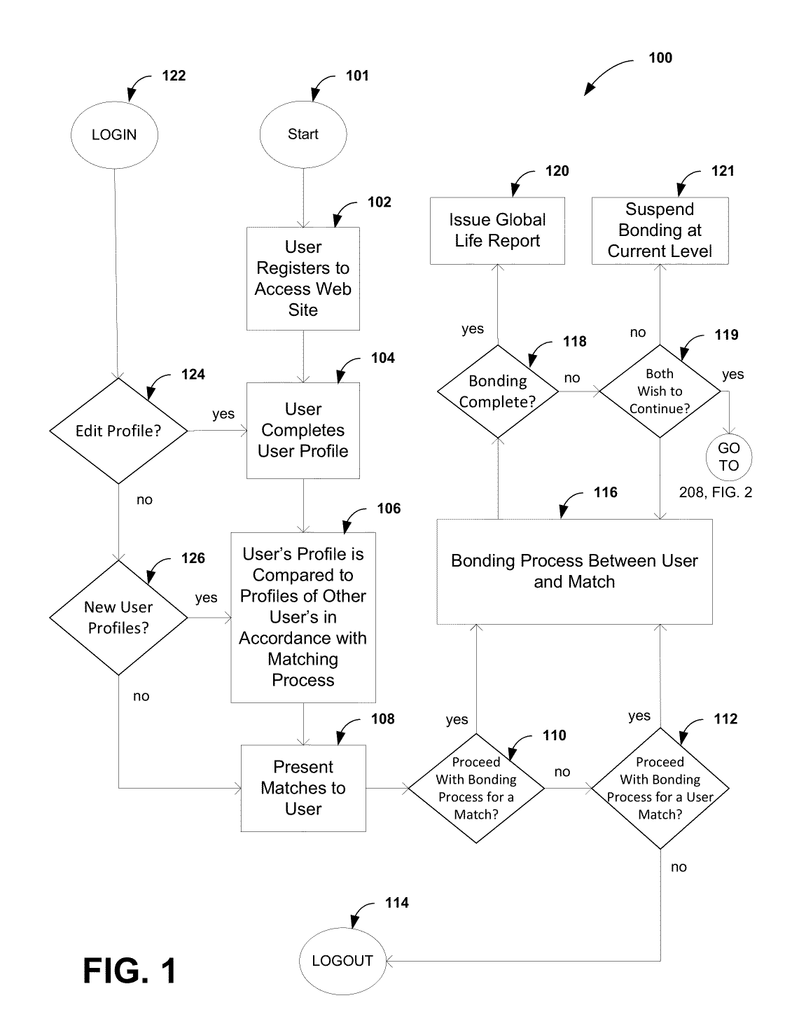

FIG. 1 illustrates a high-level procedural flow diagram 100 that represents the process of finding and establishing friendships, as a user interacts with the process as performed by the system of the invention. At block 102, a user first registers as a user of the website to join the community. Registration techniques are well known in the art. Typically, a user registers by accessing a registration web page over the Internet, and provides personal identification information, a username and a password to permits the user to login to the website.

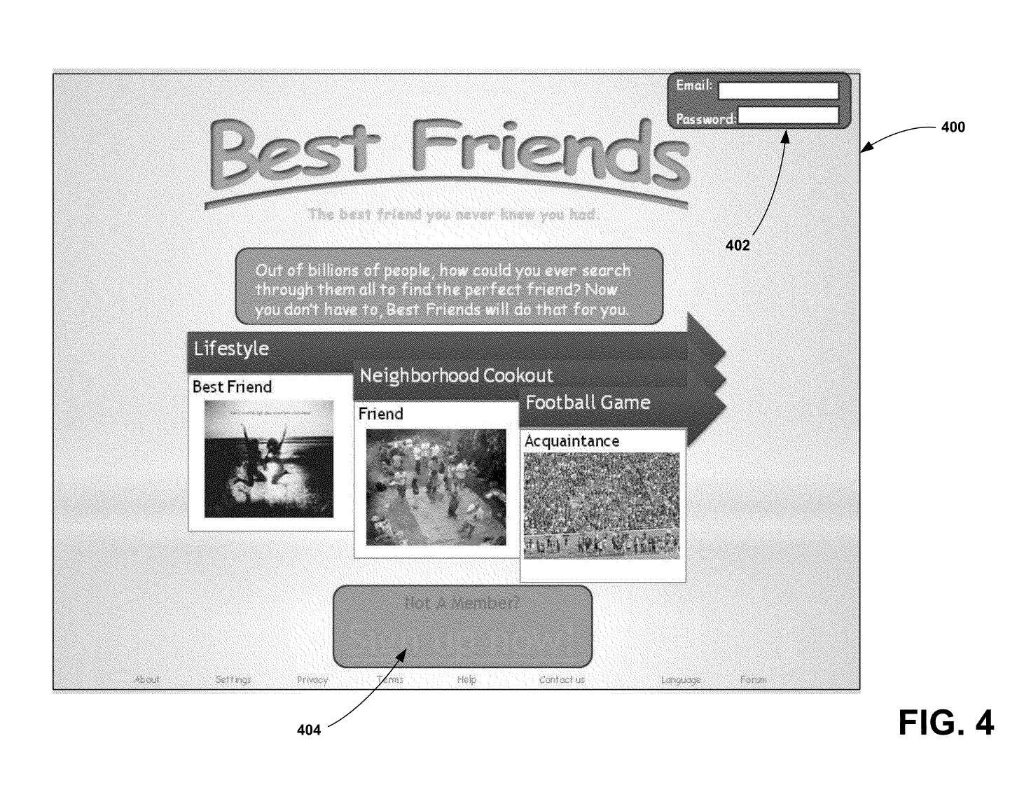

FIG. 4 illustrates an embodiment of a Home/Log-in/Sign-up web page 400 of the invention. Home/Log-in/Sign-up web page 400 serves as a graphical user interface (GUI) to users of the system of the invention, using well-known user interface techniques such as text box 402. Text box 402 provides a user input interface by which a registered user may log into the system of the invention by providing a username and password in the designated fields. If a user has not registered but wishes to, a link to a registration page is provided at text box 404. The registration page (not shown), provides a GUI by which users may provide requisite registration information, which may include (but not be limited to) a user's email address, a username, password, as well as the user's real name, residential address, etc. Once registered, the user is able to henceforth log into the system at starting point 122 of FIG. 1, through text box 402, and to access the system directly.

It should be noted that for embodiments of the invention that may be implemented on private networks and VPNs, those of skill in the art will appreciate that a user is given private access information from the network owner to restrict access to only those individuals authorized to have access. Those of skill in the art will further appreciate that the user profile can be expanded to include information regarding a user's education, personal interests and criteria for determining matches with other users as potential friends.

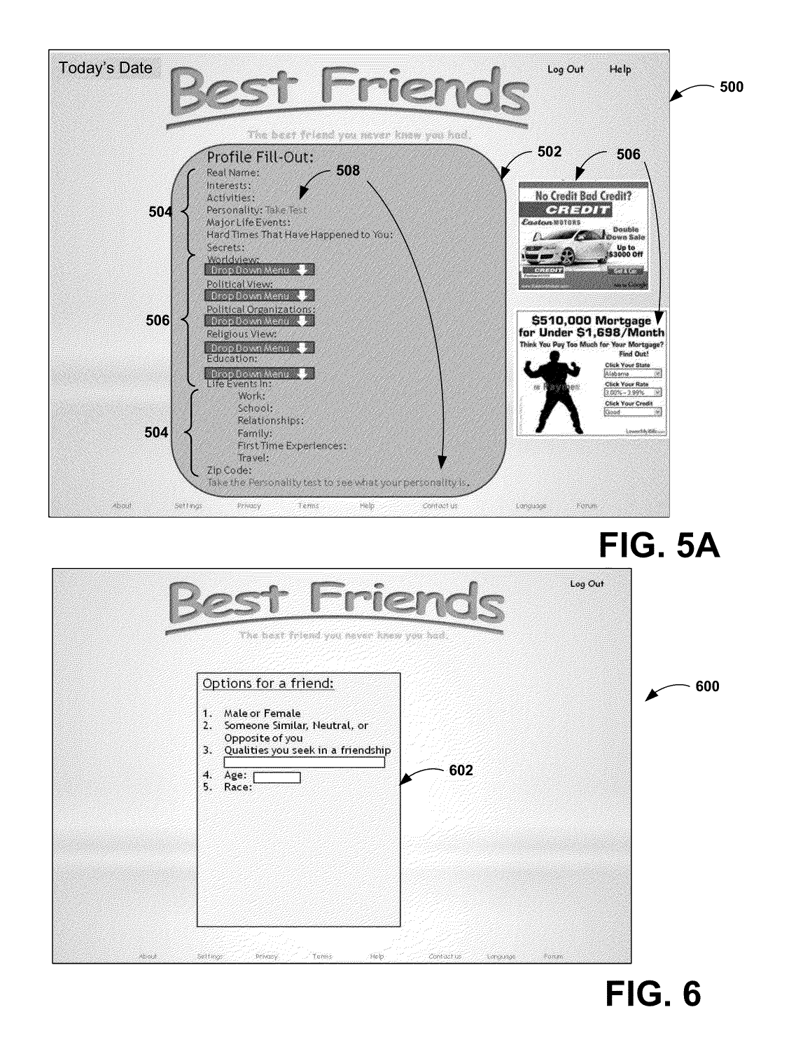

At block 104, the user is prompted to provide information to be used as part of the user's personal profile. FIG. 5A and FIG. 5B illustrate embodiments of a Profile Information input web page 500 and 550, that provide a GUI 502, 560 through which a user is able to enter the information that will form the user's profile. GUI 502, 560 prompt the user for the information necessary to create a user profile that ensures a high level of matching, thereby increasing the odds of finding true best friends through the system of the invention.

Information prompts 504, FIG. 5A can be accompanied by user interface text fields, into which users may type in responses that can be tagged by the system for direct comparison between profiles of other users for determining matches. Information prompts 506 can accompanied by user interface drop down menus from which response choices for each category may be selected and entered using a mouse or a keypad. Those of skill in the art will recognize that drop down menus limit the universe of possible responses, thereby facilitating direct comparison of user profiles for these categories. The information obtained through pages 500 and 550 provides a user profile based on a broad number of categories, including: interests, activities, personality, lifestyles, and global life events.

GUI 502, FIG. 5A can also provide links 508 to a personality test such as an abridged version of Raymond Cattell's 16 Personality Factors Test or the Meyer's-Briggs Personality Test. The results of taking a personality test can therefore provide yet another basis for matching the profiles of users as potential friends by the system. Information prompts 570 of GUI 550, FIG. 5B can be answered with a “yes” or “no” response. Those of skill in the art will recognize that this can be accomplished, for example, by clicking a check box or typing the answer into a text field.

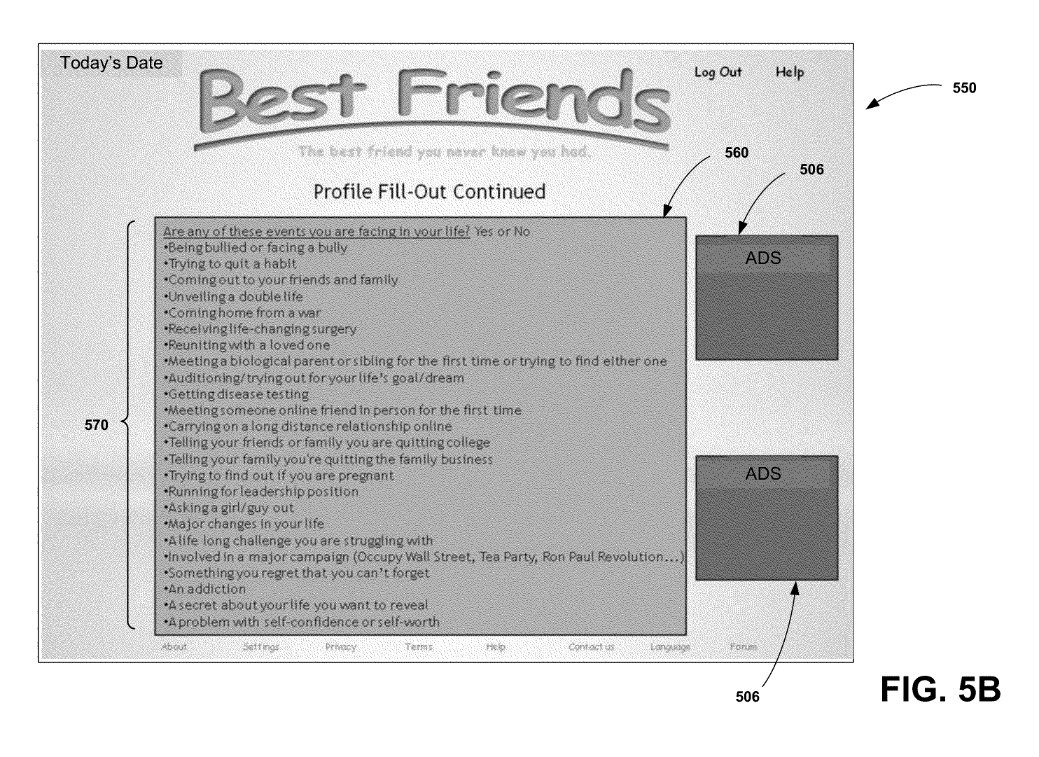

FIG. 6 illustrates a web page 600 that provides a user with the ability to specify certain matching constraints on the system of the invention through user interface 602. For example, a user can specify that matches be limited to users of a certain ethnicity, a certain religious affiliation, a certain age range, residing within a certain geographical range. In an embodiment, a user can even specify that matches be the most opposite in terms of matching criteria, rather than the most similar.

Finally, it should be noted that all of the web pages of the system of the invention may include space for advertisements 506.

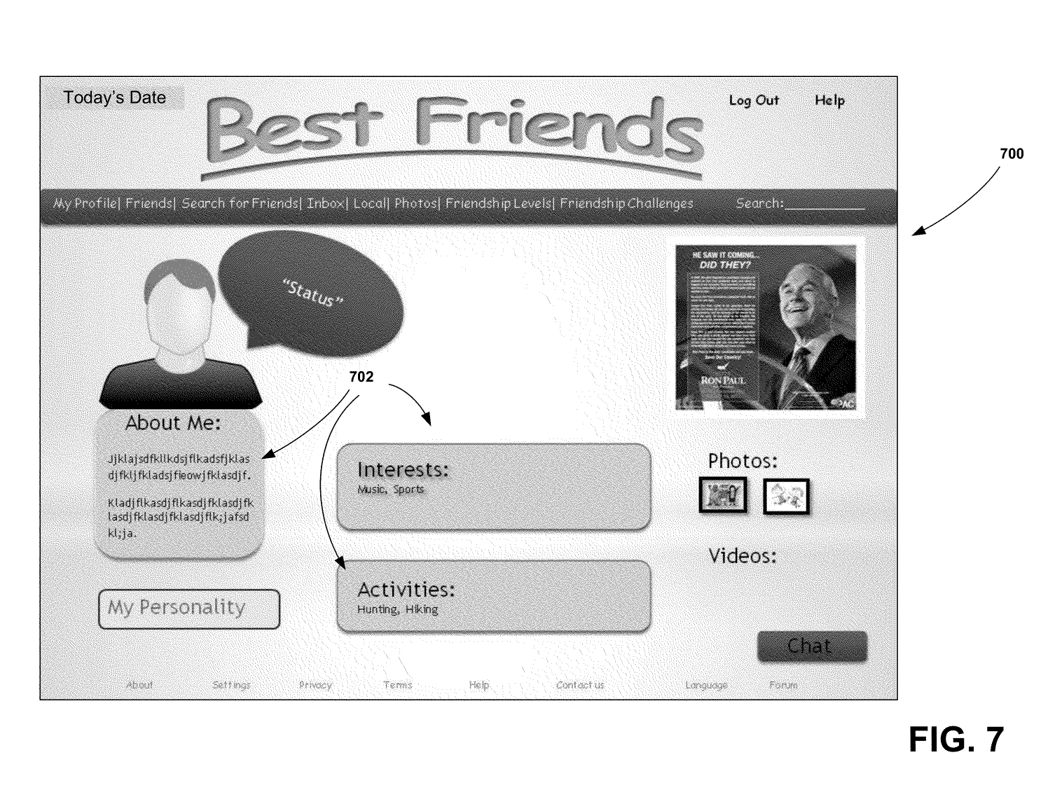

Once a user has completed entering profile information (at box 104, FIG. 1), a My Profile web page is created for each user that displays summary information to each user regarding their profile. FIG. 7 illustrates an embodiment of a My Profile page 700. In an embodiment, text boxes 702 can be used to not only display profile information entered previously by the user, but can also be used to edit the information (at box 124, FIG. 1) by adding or deleting items from those currently listed.

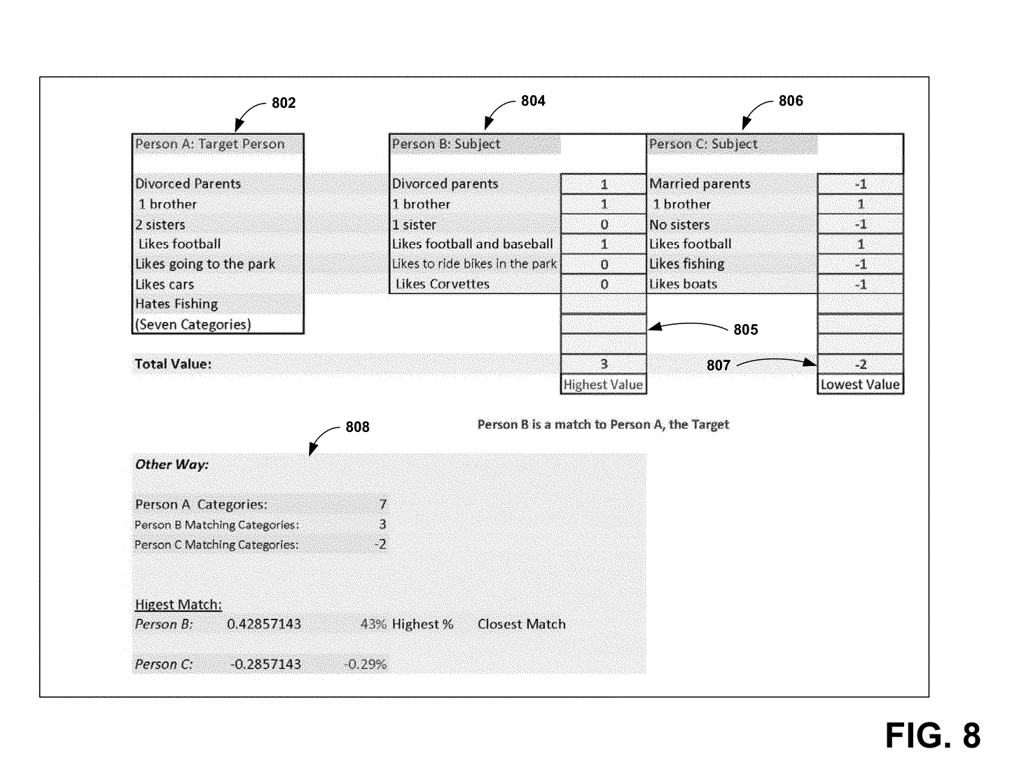

Once the user completes entering the user's profile information, processing continues to box 106, FIG. 1 where the user's profile is automatically compared to the profiles of other user's by a matching engine of the system of the invention, in accordance with any constraints specified by the users, to identify the best matches, and thus the best potential friends, for the user. FIG. 8 illustrates two different modes of comparison that may be employed. In an embodiment, matches for user A (i.e. the target) are determined by comparing an array of profile information 802 for user A, with arrays of profile information of Users B 804 and C 806 (i.e. subjects). A value of 1 is awarded for an exact match of a category, a value of zero is awarded for a neutral match, such as an inexact match, and −1 is awarded for an opposite match to achieve a match value 805 for User B and 807 for User C.

In one embodiment of the invention, the values for each subject profile are added together to generate a match value (805, 807), and the highest match value is considered the best match for User A. In the example, the best match would be User B based upon the highest match value. In another embodiment, the awarded match values can be used to determine a percentage of matched categories. The subject user with the highest percentage of matched categories is than assessed as the best match. Those of skill in the art will recognize that one of the advantages of awarding a negative number for a complete mismatch is that it is easy to invert the best match based determination to one of the greatest mismatch, should user A specify an exact opposite as a constraint. Those of skill in the art will further recognize that the example given in FIG. 8 is a small sampling of the number of categories and criteria that are compared in determining matches, as can be seen from the information prompts listed on web pages 500 and 550.

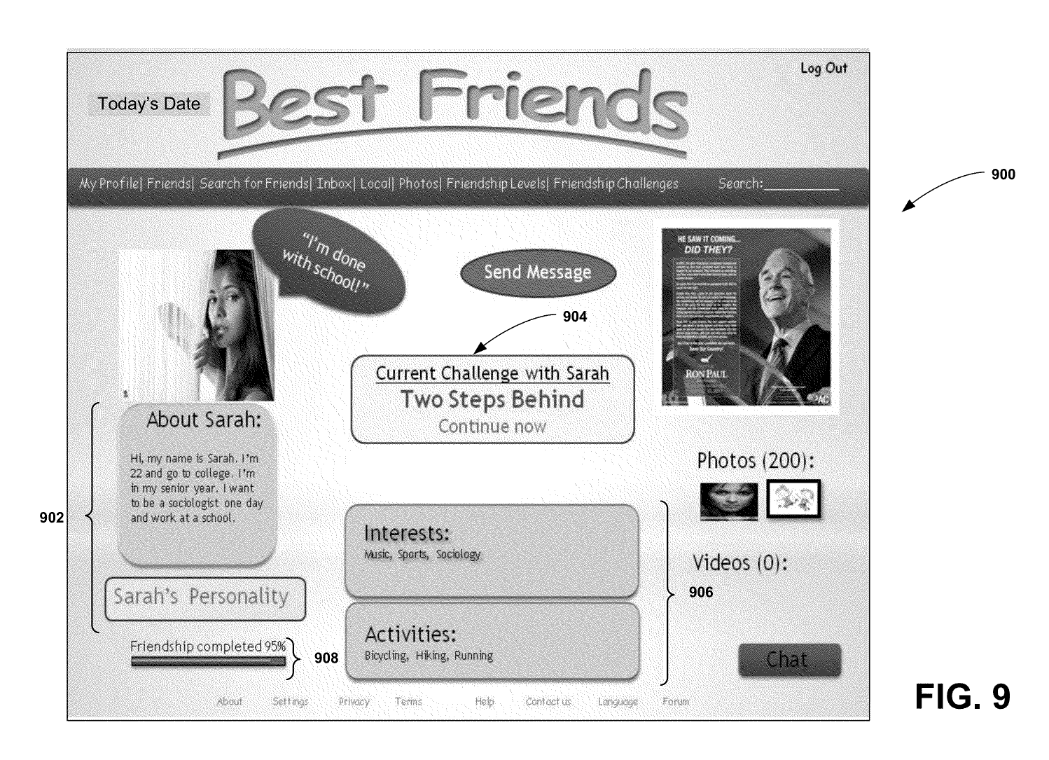

Once match values for the target user are determined by the matching process disclosed above, the highest ranking matches are presented to the target user at block 108 of FIG. 1. In an embodiment, the matches can be presented on the various web pages of the system. FIG. 9 illustrates a Friends page 900 to which the target user can navigate to see a synopsis of the user's friends, including a graphic 902 that displays potential friend matches listed in order beginning with the currently best matches. Those of skill in the art will recognize that this box 902 could be listed on other target user web pages, such as the user's My Profile page 700.

It should be noted that the matching process (at 106, FIG. 1) is continuously performed for each user as a target user to encompass users that have recently joined as subject users (at 126, FIG. 1), and to take into account any edits made to users' profiles (at 124, FIG. 1) that may affect the match scores of previously existing subject users. Thus, each time the matching process is run, the top matches presented to a target user (at 108, FIG. 1) will be updated to reflect these changing conditions.

Once presented, the target user may choose to contact one of the presented matches to request the user match to participate in the friendship bonding process. In an embodiment, a message can be sent to the subject user match, and if the subject user match agrees, processing continues at block 116 where the target user and user match engage in the bonding process, which will be described in more detail below. This step is represented by the decision block 110 of FIG. 1. If the subject user match does not agree, or if the user wishes to bypass the matching process by choosing a user based upon, for example, browsing profiles, processing continues at decision block 112. The target user can send a request to the non-matched subject user, and if the subject user agrees, the target and subject users can enter the bonding process at block 116. If the subject user does not agree, the user can proceed to anywhere in the system the user is allowed, or the user can simply logout at 114.

The bonding process of the present invention is executed by a bonding engine of the system of the invention, which includes at least two (and preferably more than two) levels of bonding, with each of the levels including at least one (and preferably more than one) challenge that must be met by the two users to proceed to the next level of bonding. The challenges of the lowest level of bonding are typically less onerous and difficult, and thus require a lower level of intimacy or depth of participation between the users. As the challenges of a particular level of bonding are met, and as the levels of the bonding process itself increase, the level of difficulty and the depth of involvement between the two users increases, thereby increasing the levels of intimacy or bonding between the users.

The bonding process takes potential friends through activities (i.e. challenges) that require the users to work together, to share intimate information with one another, and to demonstrate reliance on one another. These are all ways in which bonds between friends can be formed. The challenges start out at a very basic level, to emulate the process of two people who are strangers, who can be determined to have a good chance of being friends through the matching process, and connecting them first as “acquaintances.” Those of skill in the art will recognize that this is similar to how you would meet someone at a sports game just by sitting by them.

A challenge is a type of task that users, who are engaging in the bonding process with one another, complete with each other online through the system of the invention. It can be telling a story, sharing a poem, asking a question, or whatever the particular challenge requires of the participant users. The challenges get more personal as the bonding process evolves within a given level, each level of the process becomes more personal and requires more trust from one another.

Photobook building (i.e. Photo/Video Sharing) is a process that encourages users to upload a photo or video related to each challenge as part of the bonding process. Thus, a photobook can be built while completing each challenge and is thereby associated with that challenge. At the completion of the task(s) set forth for each challenge, the photobooks created while completing the challenge will play in order from the beginning like a slideshow, providing a review of the friendship as it has progressed thus far. The photobook is an exciting way to have fun sharing photos, while at the same time creating a memory of your friendship

In an embodiment, an “achievement” step is performed after each challenge has been complete. The achievement step can serve to inform, debrief, or provide an opportunity to discuss material related to the completed challenge or the next challenge, to incentivize the users to continue, and further to congratulate each user for their accomplishment. For example, after completing a lower level challenge, each user may be permitted to view the other user's complete profile. Perhaps the completion of the next challenge can lead to the ability to unlock all of the other user's videos and pictures.

As each challenge within a level is met, and as friends move from one level of the bonding process to the next, a friendship meter to be updated with each achievement to indicate a visual and/or numerical representation of the progression of the friendship (e.g. a bar and a percentage of the number of challenges completed over total number of challenges).

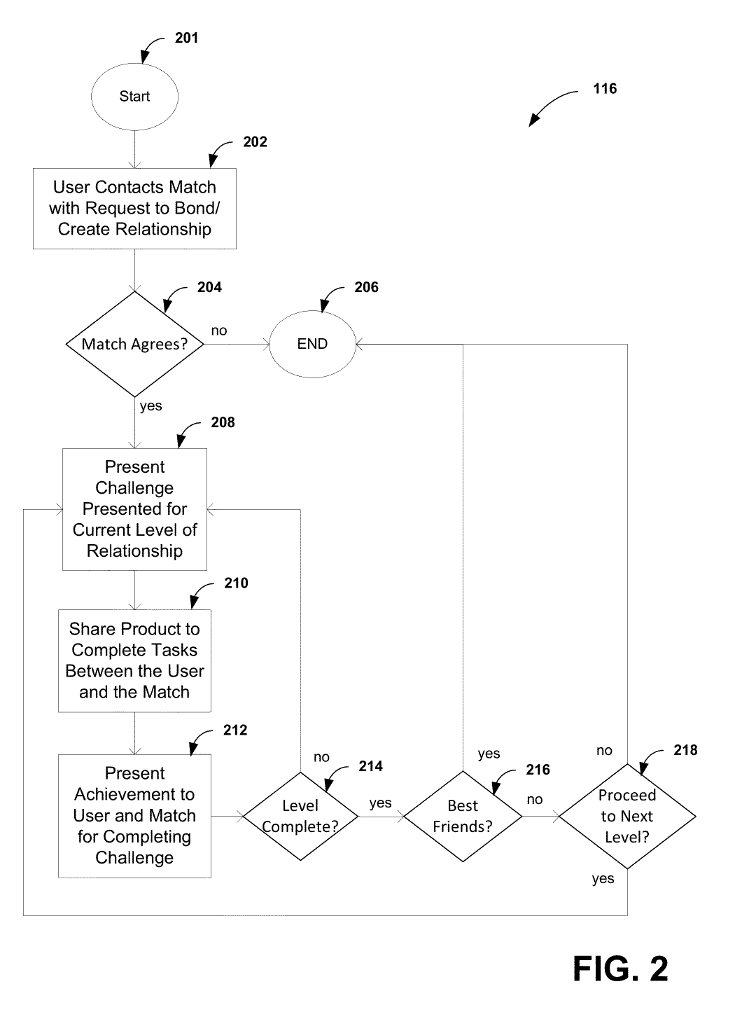

An example of two user's choosing to enter the bonding process at block 116, FIG. 1 is now presented in view of the more detailed procedural flow diagram of the bonding process as depicted in FIG. 2. Beginning at Level 1, a first challenge that can be considered to have been met is making initial contact. This challenge is implicitly given based on the notification of each other as matches. This challenge is therefore implicitly met when the two matched users agree to start the bonding process at decision block 110, FIG. 1. This process of contact and agreement is represented by the blocks 202 and 204 of FIG. 2. If the match contacted match does not agree, then the process ends at 206.

Thus, once both users decide to contact each other and start the process, the first achievement will be presented to the users by the system of the invention. In an embodiment, the system can send a message to both user's such as “First Achievement! Initial Contact Challenge Completed! Congratulations, you have completed your first challenge. You are now officially acquaintances! You will be able to see your acquaintance's profile, but not his/her full profile. Keep working at the challenges to see be able his/her full profile and to develop a friendship. This is the start of a process that may lead to a great relationship with a best friend one day. Continue the good work and find out more about your acquaintance.”

The achievement informs the users that they are now acquaintances and that they should continue their challenges together to become best friends. Initially, they will be able to see each other's profiles but only with very limited information. After some of the challenges are completed, their full profiles will be unlocked to the other person to view.

A level 1 challenge is now presented to both of them at block 208, FIG. 2 and which can be called something like, “Friday Night Party.” The challenge issued to both users can be:

“Friday Night Party: To get to know your new acquaintance, ask what his/her real name is and what some of his/her most basic interests and activities are. Those of skill in the art will recognize that such an early level 1 challenge can be described by any number of titles that describe a scenario where two people are at the earliest stages of getting to know on another. Another example might be: “Greet Your Neighbor at Church.”

In an embodiment, the system can also suggest to the user's that creating a photobook is an exciting way to have fun sharing photos, while at the same time creating a memory of their friendship. With each challenge, they can upload a photo or short video related to the challenge and with each achievement, they will be able to their relationship through a slideshow!

Once the two users exchange their real names and some information, and each upload their first picture at block 210, FIG. 2, a second achievement is presented to both of them at block 212, FIG. 2. This achievement message can read “Achievement! Friday Night Party Challenge Completed! Congratulations, you can now view your acquaintance's full profile except photos and videos. Complete the next challenge to unlock his/her photos and learn more about him/her. Also as a result, the friendship meter can be updated to reflect the advancement in their relationship.

If this is not the last challenge of the level, then processing determines this at 214, and processing returns to block 208. After some predetermined number of log-ins, the next challenge will be presented to the two users. The challenge message might look something like “Night Out for Dinner: Ask your acquaintance something about one of his/her interests or activities that he/she previously listed. Ask about a general, non-personal type of interest or activity rather than a personal one. (Example: One of his/her favorite activities is baseball so you may ask, “What is your favorite baseball team?”). Upload a picture or short video of one of the interests or activities that you just described.

At block 210, the two users talk about how they both watched the Cardinals game and the great comeback the Cardinals had, they each upload another picture about them playing baseball. An achievement message is once again presented at block 212 to both of them for completing the current challenge. The message may look something like “Achievement! Night Out for Dinner Challenge Complete! Congratulations, you can now view your acquaintance's photos on his/her profile. Complete the next challenge to continue learning about your acquaintance and unlock his/her videos. The photobook for this challenge will be playable back in order at this point.

The bonding process continues with challenges of increasing levels of participation being issued and shared levels of confidence being required to complete the challenges. A final challenge for this level is issued once again at 208, that might read “Reap What You Sew: Friendship is not a 50%-50% relationship, but is a 100%-100% relationship and requires both people to give in order to receive. Ask your acquaintance what types of attributes or elements he/she desires in a friendship.” Upload a photo or short video that represents what friendship means to you.”

Once the tasks are met by sharing the information at block 210, an achievement message is issued at block 212 that might read, “Final Acquaintance achievement! Reap What You Sew Challenge Completed! Congratulations, you have completed all of the challenges in the Acquaintance Level of Friendship. You and your acquaintance now have the option stay at this level of friendship or advance to the next level of friendship. The next level of challenges will be more fun, but also more personal which will strengthen your friendship. If you decide to stay at this level of friendship you can still come back later and continue the friendship challenges if your friend is still willing.”

Thus, processing proceeds at decision block 214 where this time it is determined that the current level has been completed and thus processing continues to decision block 216 where it is determined if this is the final level where they would deemed best friends. If the answer is no, processing proceeds to end 206 and processing returns to decision block 118 where it is determined that the bonding process is not complete, and processing proceeds to decision block 119 where it is determined if both users wish to continue to the next level bonding. If yes, processing continues at block 208, FIG. 2, where the first challenge of the next level of bonding. If no, the bonding process is suspended at the current level of bonding until both users agree to resume the process.

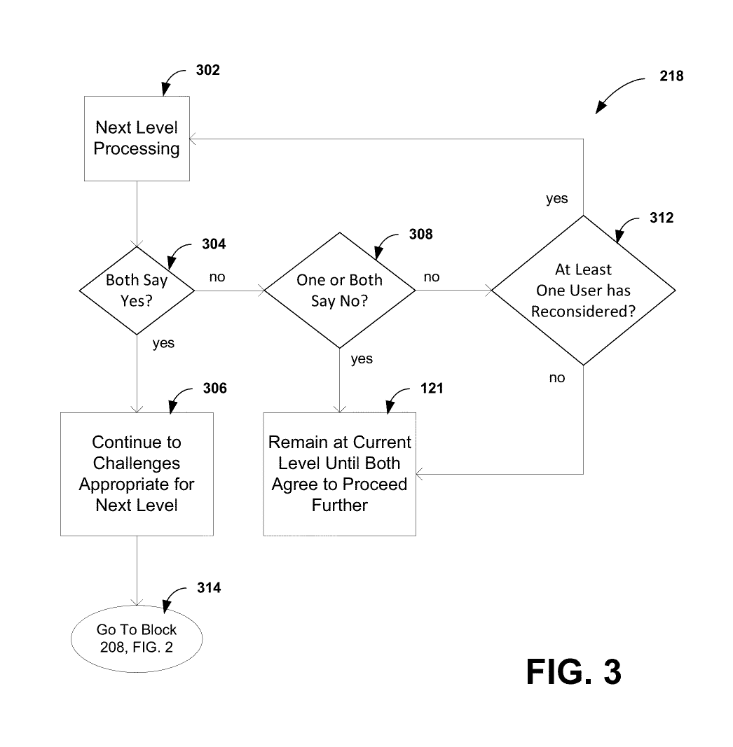

FIG. 3 illustrates a more detailed flow for the process performed at decision block 218 of FIG. 2, in determining whether processing will continue to the next level of bonding. As is clear from FIG. 3, only if both users agree at decision block 304, will processing proceed to the next level of bonding between the users. If either or both users say no, at decision block 308 processing moves to block 121, FIGS. 1 and 2, at which point the bonding process is suspended. If at least one of the user's reconsiders at a later time, this is determined at decision block 312, where processing resumes at back at block 302, where the other user is re-contacted and processing repeats as described above.

FIG. 9 illustrates a Friend's Profile web page 900, which represents profile information of a friend of a user. The page provides profile information 902 of the friend, such as her description of herself and her personality in accordance with a personality test taken by the friend. In addition, global profile information 906 from the friend's profile is also displayed. A visual indication of the level of friendship achieved with the friend is also displayed in the form of friendship meter 908. Finally, any current outstanding challenges 904 that the user has with the friend (e.g. Sarah) is displayed, as well as a link by which to continue with the challenge is also provided.

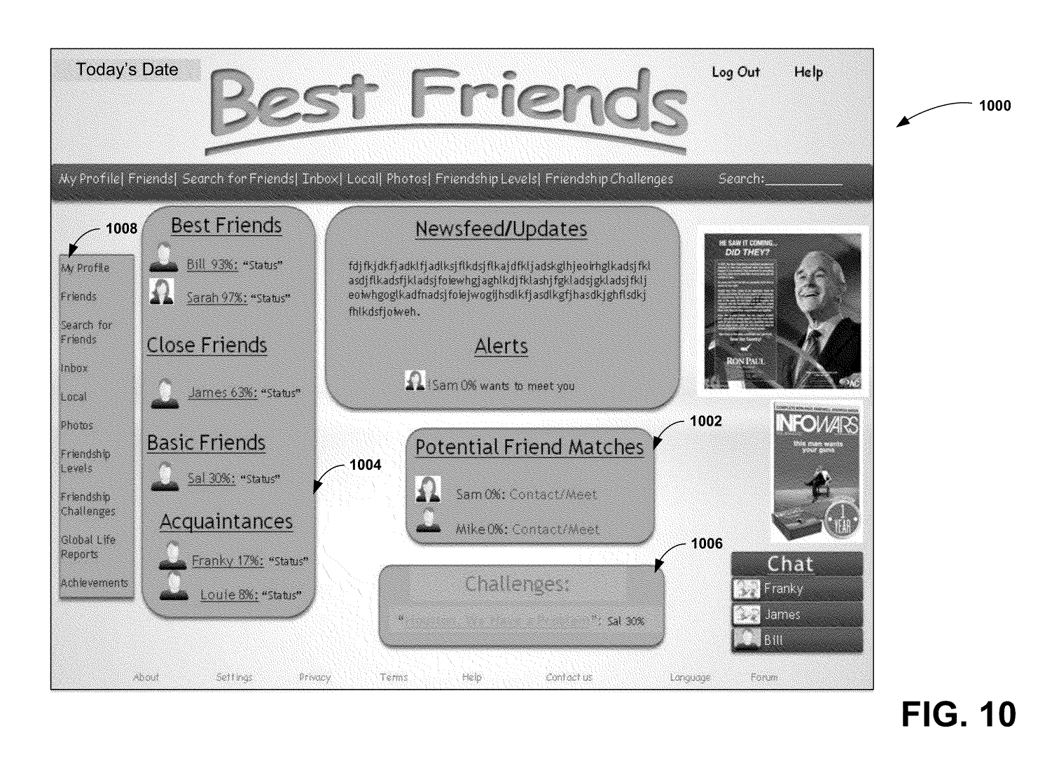

FIG. 10 illustrates an embodiment of a home web page 1000 of the invention displayed for a user immediately upon logging in. The home page 1000 provides a list of current best matches 1002, as well as any challenges that are currently outstanding with the user's friends 1006. A summary of recent friends with whom the user as interacted 1004 is also provided, as well as a friendship status for each friend listed. A series of links to other pages of the site are also provided.

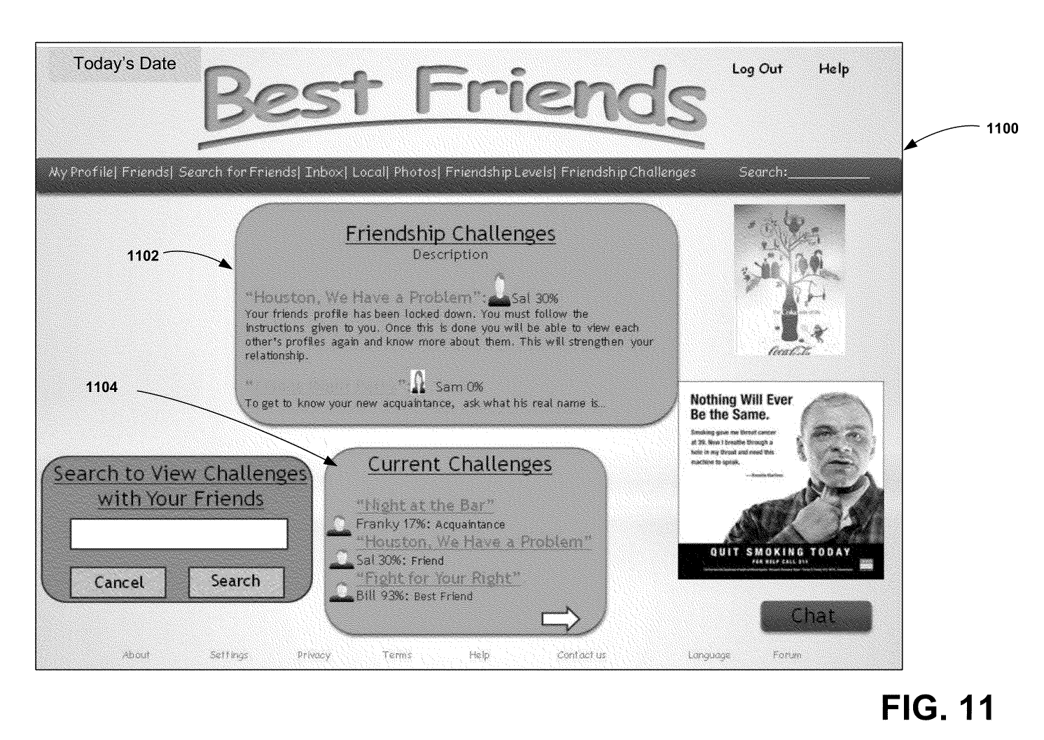

FIG. 11 illustrates an embodiment of a friendship challenge web page 1100 of the invention, which provides the details of a selected one of the challenges 1102. A display 1104 of all of the current challenges that the user has been presented with for various friends during the bonding process as previously discussed, are also listed and can be selected for display of the details at 1102 by way of the links provided.

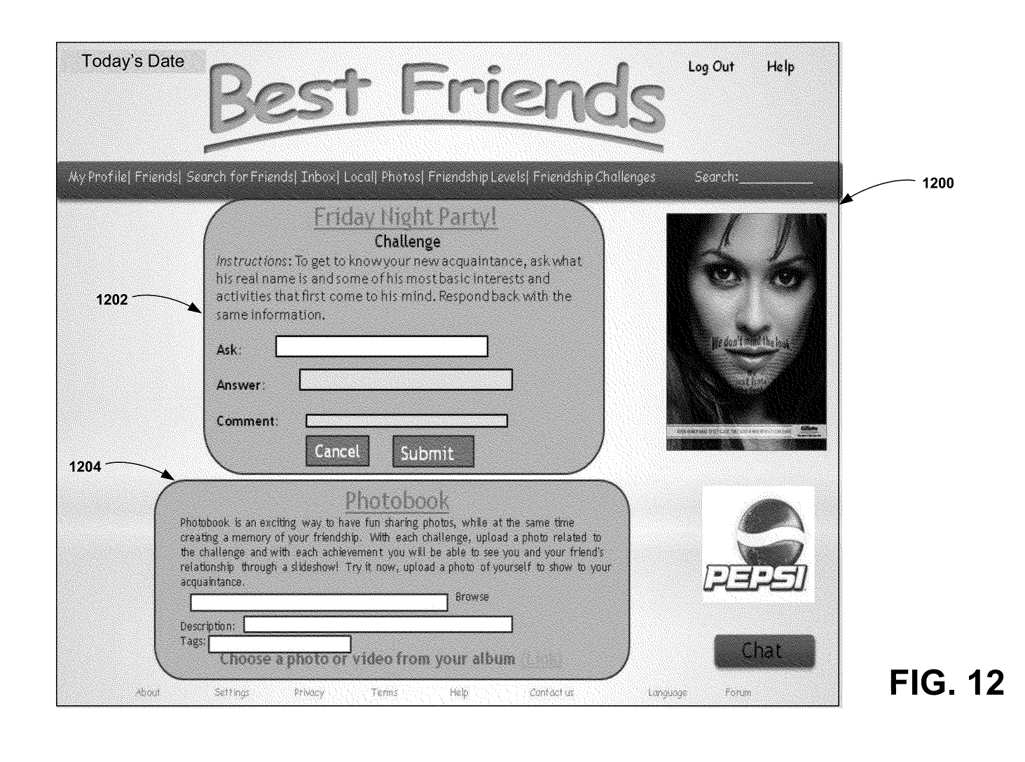

FIG. 12 illustrates an embodiment of a challenge page 1200 that provides an input interface 1202 by which a user can input the information requested for meeting a selected challenge presented by the bonding process. This page can be activated for a specific challenge by a link provided at 1002, FIG. 11. The page 1200 further includes an photobook input interface 1204 by which the user can provide a photo or short video for the photobook that will be associated with the challenge.

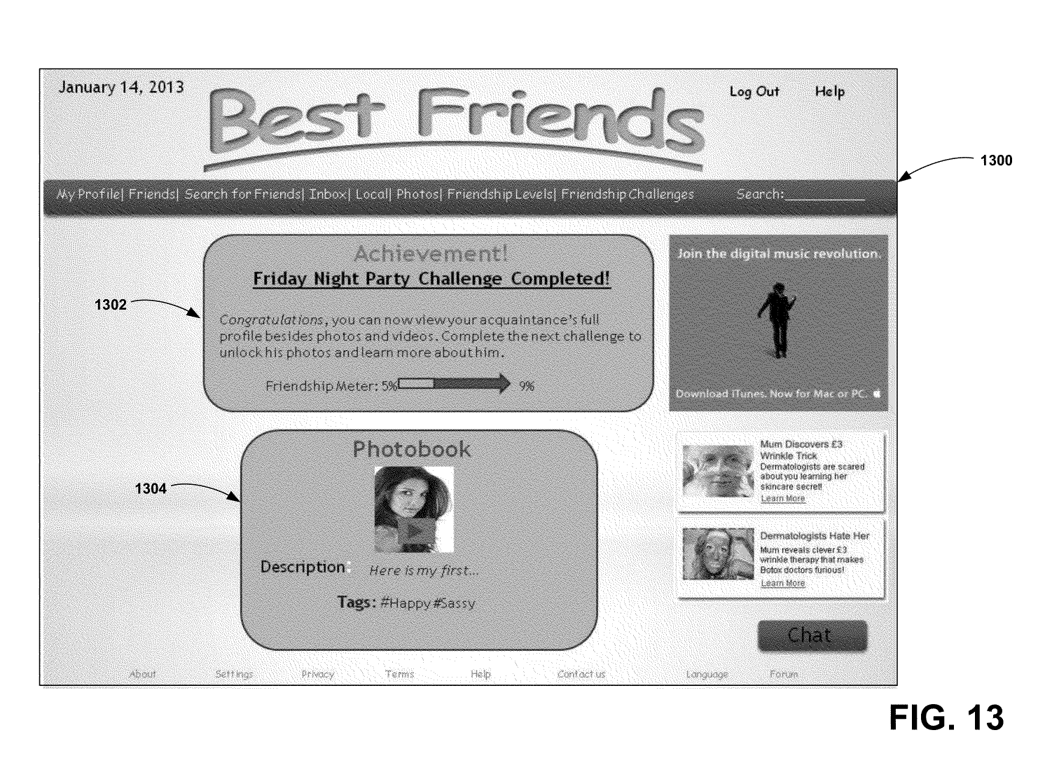

FIG. 13 illustrates an embodiment of an achievement web page 1300 of the invention pertinent to a particular challenge met with a particular friend, the achievement being presented to each user when a challenge is completed as discussed above. Text box 1302 provides the achievement message and an update to the friendship meter in view of the newly completed challenge. The link 1304 for playing the photobook created while completing the challenge can be played by the user.

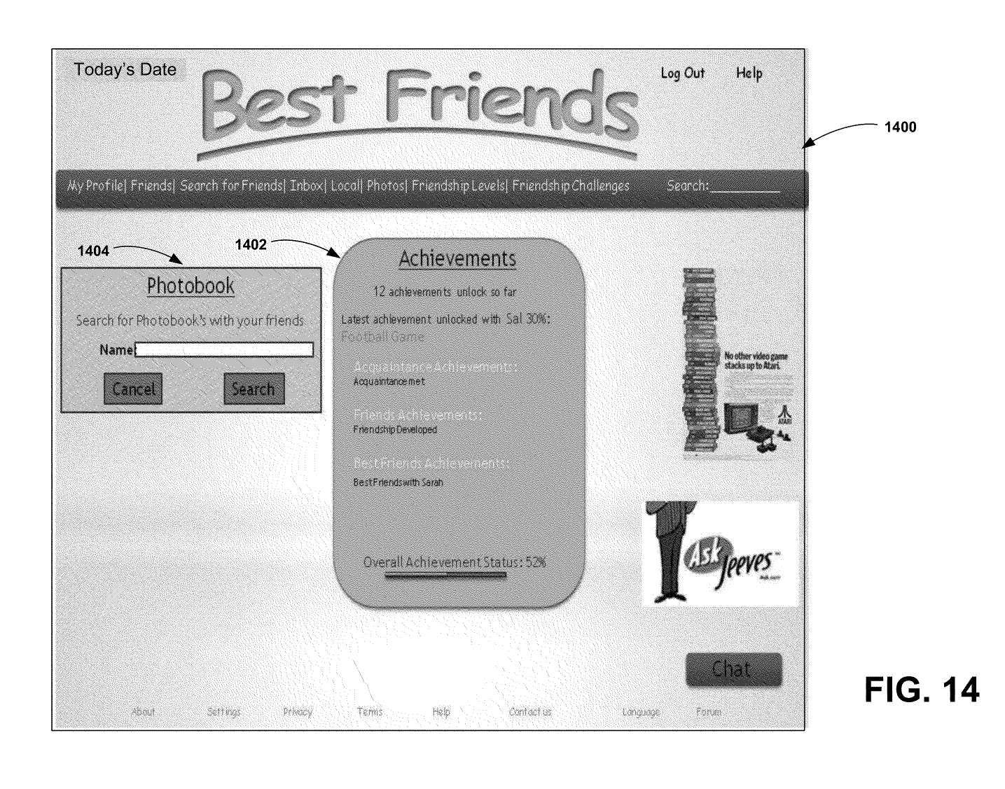

FIG. 14 illustrates an embodiment of a global achievements/photobook web page 1400 of the invention. This web page 1400 provides a list 1402 of recent achievements by the user and links thereto. This web page 1400 also provides a search box 1404 by which photobooks may be globally searched by friend.

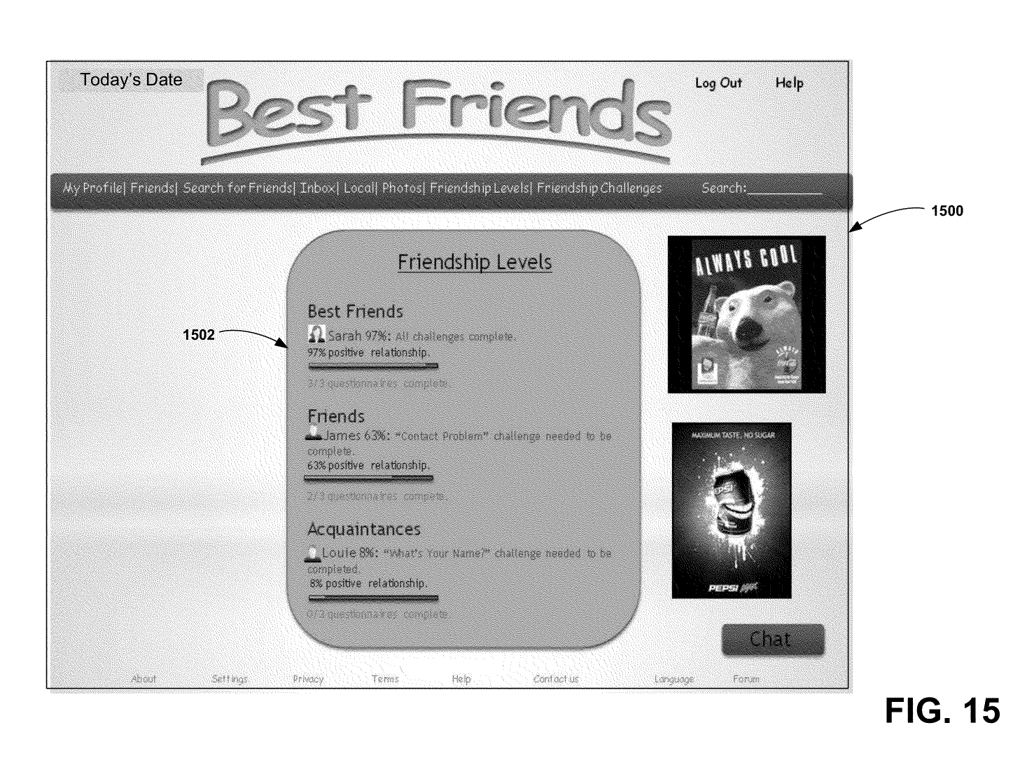

FIG. 15 illustrates an embodiment of a global friendship levels web page 1500 of the invention, that provides a listing 1502 of friendships by friendship levels, as well as any outstanding challenges for each friendship listed.

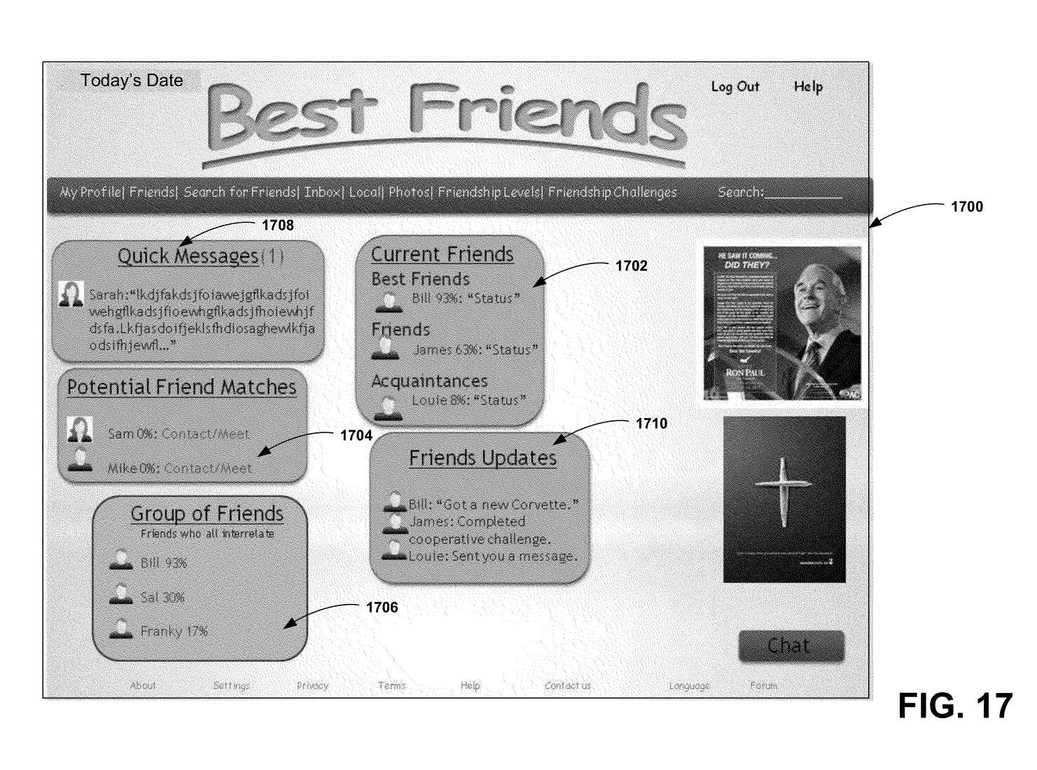

FIG. 17 illustrates an embodiment of a global friends web page of the invention, that provides a listing 1702 of current friends by friends level. The page also provides a listing of the current best potential matches 1704, groups of interrelated friends 1706 that have all been through the bonding process with one another, snippets of messages 1708 from friends that are linked to the user's inbox, and updates to the status of friends 1710.

If it is determined at block 216 that the highest level of “best friends” has been achieved, processing ends at block 206 and returns to block 120, where a global life report is issued to both users. A global life report shows the users how they relate to each other on a global level.

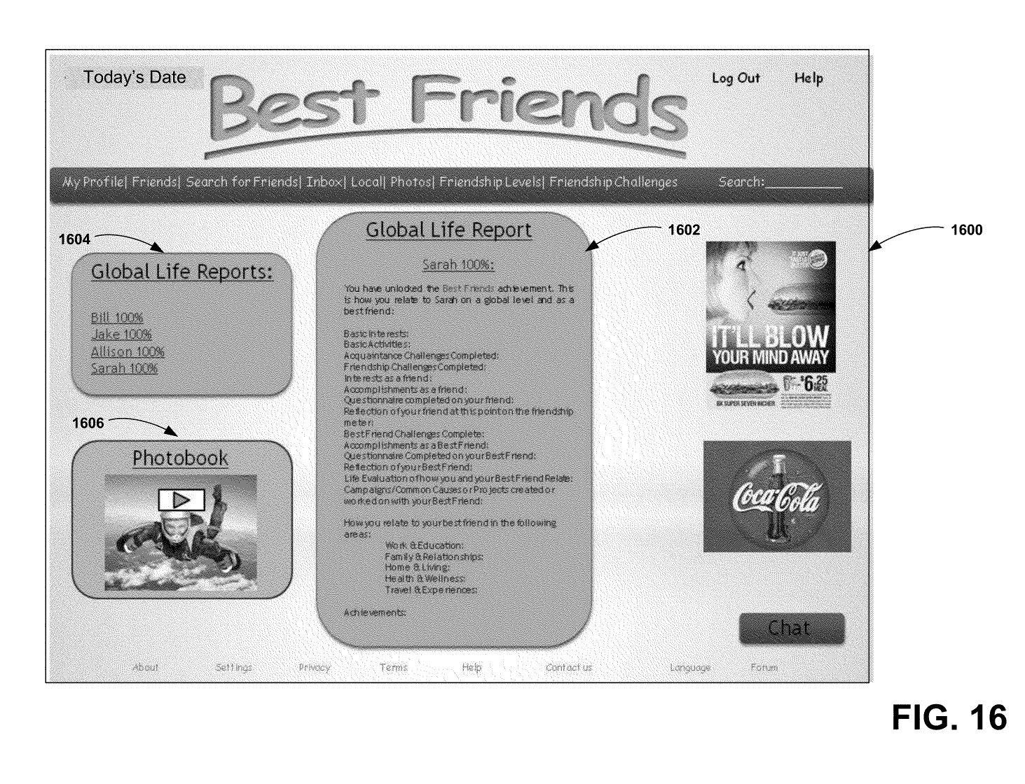

FIG. 16 illustrates an embodiment of a global life reports web page 1600 of the invention that presents the global report 1602 upon completion of best friend status with another user after completing all levels of the bonding process. The page provides a list 1604 of global reports presented for other friends and links thereto. Finally, a link 1606 to play the entire photobook, that chronicles the bonding process from the first challenge of the first level all of the way up to the final challenge of the final or best friend level, is provided for review.

A “Global Life Report” is basically a review of the relationship and a “look back” at what the people went through that eventually led them to become best friends. It is like another bonding tool because people will remember how much they've invested in the relationship and how great it's been. A Global Life Report will be given once a person completes every “Challenge” in the Bonding Process. It will label all the challenges a person did with his/her friend, the information they've revealed with each other, and the info they originally filled out when filling out a profile which was used to match them (global life events, worldviews, political views . . . ). This will also show all the photos/videos that the people have uploaded for the Photobook (photo/video sharing) process.

The global life report is intended to show how one best friend relates to the other best friend on a “global” level. The report will also show how the friendship progressed from an acquaintance to best friend and all the challenges and achievements completed. It will show the ways that the two friends relate to each other from beginning to end. This report will be an incentive and reinforcement for their commitment to develop their best friend through the system of the invention.

What is claimed is:

1. An online system for identifying potential friends among users and building real friendships therebetween, the system comprising:
a database for receiving and storing user global profile information for each user;
at least one computer processing device coupled to the database, the computer processing device accessible to the users over a network;
a matching engine for identifying best matches between users based on a comparison of the profile information of each of the users; and
a bonding engine for leading matched users through a bonding process to reinforce and deepen their friendship.

2. The system of claim 1 wherein the bonding process comprises a plurality of levels, each of the levels being increasingly more personal.

3. The system of claim 2 wherein each of the plurality of levels comprises a plurality of challenges that must be met by the matched users before they can move on to the next of the plurality of challenges.

4. The system of claim 3 wherein each of the plurality of challenges must be performed before the matched users can move from a current level of friendship to a next level of friendship.

5. The system of claim 3 wherein meeting each of the challenges includes uploading media files to create a photobook by which to chronicle the bonding process.

6. The system of claim 1 wherein the matching process includes the matching of user profile information selected by a user from a dropdown menu of a user interface.

7. The system of claim 1 wherein the matching process includes matching user profile information that is text typed into a text field of a user interface.

8. The system of claim 1 wherein the matching process compares individual pieces of user profile information for two users, and assigns a positive value for an exact match of the information, assigns a negative value for a complete lack of a match of the information, and a neutral value for a partial match of the information.

9. The system of claim 8 wherein an overall match value between users is obtained by adding the assigned values.

10. The system of claim 8 wherein an overall match value between users is obtained as a percentage of matched pieces of profile information versus total pieces of compared profile information.

11. A method for identifying potential friends among users and building real friendships therebetween, the method comprising:
providing a database for receiving and storing user global profile information for each user;
providing at least one computer processing device coupled to the database, the computer processing device accessible to the users over a network;
identifying best matches between users based on a comparison of the profile information of each of the users; and
leading matched users through a bonding process to reinforce and deepen their friendship.

12. The method of claim 11 wherein the bonding process comprises a plurality of levels, each of the levels being increasingly more personal.

13. The method of claim 12 wherein each of the plurality of levels comprises a plurality of challenges that must be met by the matched users before they can move on to the next of the plurality of challenges.

14. The method of claim 13 wherein each of the plurality of challenges must be performed before the matched users can move from a current level of friendship to the next level of friendship.

15. The method of claim 13 wherein meeting each of the challenges includes uploading media files to create a photobook by which to chronicle the bonding process.

16. The method of claim 11 wherein the matching process includes the matching of user profile information selected by a user from a dropdown menu of a user interface.

17. The method of claim 11 wherein the matching process includes matching user profile information that is text typed into a text field of a user interface.

18. The method of claim 1 wherein the matching process compares individual pieces of user profile information for two users, and assigns a positive value for an exact match of the information, assigns a negative value for a complete lack of a match of the information, and a neutral value for a partial match of the information.

19. The method of claim 18 wherein an overall match value between users is obtained by adding the assigned values.

20. The system of claim 18 wherein an overall match value between users is obtained as a percentage of matched pieces of profile information versus total pieces of compared profile information.
